(19) United States
(12) Patent Application Publication
(10) Pub. No.: US 2014/0263909 A1
(43) Pub. Date: Sep. 18, 2014

(54) PUMP DISPENSER BOTTLE HANGER

(71) Applicant: JYIN SHENG CO., LTD., Huatan Township (TW)

(72) Inventor: Yu-Lung TSAI, Huatan Township (TW)

(73) Assignee: JYIN SHENG CO., LTD, Huatan Township (TW)

(21) Appl. No.: 13/800,080

(22) Filed: Mar. 13, 2013

(51) Int. Cl. B05B 15/06

(52) U.S. Cl. CPC B05B 15/061
USPC 248/313

(57) ABSTRACT

A pump dispenser bottle hanger that fits different pump dispenser bottle neck dimensions includes a hanging board and a fixing board. Two surfaces and two ends of the hanging board are defined as top and bottom surfaces and front and rear ends, respectively. The hanging board has a clamping slot that opens into the hanging board from the front end toward the rear end and penetrates the top and bottom surfaces. The clamping slot has front, middle, and rear segments arranged sequentially in a direction from the front end to the rear end. The rear segment has a stop edge. The middle segment has two opposing oblique edges connected to the stop edge. The oblique edges each extend from the junction of the oblique edge and the stop edge and in the direction of the front segment. The fixing board extends downward from the hanging board.

### BACKGROUND OF THE INVENTION

1. Technical Field

The present invention relates to pump dispenser bottle hangers, and more particularly, to a pump dispenser bottle hanger for use with a pump dispenser bottle with a plurality of neck dimensions.

2. Description of Related Art

Plenty of cleansing lotions, such as hand washes, shampoos, and shower gels, are commercially available. Their containers are mostly pump dispenser bottles out of which users take the cleansing lotions conveniently. Furthermore, hangers for use with pump dispenser bottles are commercially available. Taiwan utility model patent 502611 provides a hanger which comprises a brace and a supporting rod. The brace clamps the bottle neck of a pump dispenser bottle, such that the brace is fixed between a cap and a body cylinder as soon as the cap equipped with a press head is screwed tightly to the bottle neck. The supporting rod is fixed to a wall surface and adapted to allow the pump dispenser bottle to be hung on the wall surface. The hanger spares a platform area which might otherwise be required to carry the pump dispenser bottle, precludes the pump dispenser bottle from toppling over, and prevents the bottom of the pump dispenser bottle from breeding fungi or accumulating dust.

However, the brace of the pump dispenser bottle hanger is applicable to bottle necks with one specific dimension only and thus cannot be for use with pump dispenser bottles with different neck dimensions. Furthermore, the supporting rod extends downward from the wall surface to reach the brace. Hence, not only is the pump dispenser bottle likely to shake, but it is also difficult for a user to operate the press head single-handedly, not to mention that the supporting rod is likely to deform or sever.

### SUMMARY OF THE INVENTION

In view of the aforesaid drawbacks of the prior art, it is an objective of the present invention to provide a pump dispenser bottle hanger that applies to pump dispenser bottles with a plurality of neck dimensions, features high structural strength, is unlikely to damage, and enables the pump dispenser bottles to be easily pressed.

In order to achieve the above and other objectives, the present invention provides a pump dispenser bottle hanger comprising a hanging board and a fixing board. The hanging board has two surfaces defined as a top surface and a bottom surface, respectively, and two ends defined as a front end and a rear end, respectively. The hanging board has a clamping slot opening into the hanging board from the front end toward the rear end and penetrating the top surface and the bottom surface. The clamping slot has a front segment, a middle segment, and a rear segment arranged in sequence in the direction from the front end to the rear end. The rear segment has a stop edge. The middle segment has two opposing oblique edges connected to the stop edge. The two oblique edges each extend from the junction of the oblique edge and the stop edge and in a direction of the front segment. The fixing board extends downward from the hanging board.

Hence, the pump dispenser bottle hanger enables a pump dispenser bottle to be fixed to a hanging board and enables a fixing board to be fixed to a wall surface, such that the pump dispenser bottle is hung on the wall surface. Moreover, a clamping slot of the hanging board clamps a neck of the pump dispenser bottle with neck dimensions which fall into a specific range. Accordingly, the pump dispenser bottle hanger is applicable to pump dispenser bottles with a plurality of neck dimensions. Furthermore, the fixing board extends downward from the hanging board. Therefore, the pump dispenser bottle hanger manifests high structural strength, is unlikely to deform or sever, and allows users to exert a downward force on the pump dispenser bottle to thereby press a press head of the pump dispenser bottle easily.

Structures, features, assembly, and usage of the pump dispenser bottle hanger of the present invention are described in detail below. However, persons skilled in the art understand that the description below and the specific embodiments of the present invention are illustrative of the present invention rather than restrictive of the claims of the present invention.

### BRIEF DESCRIPTION OF THE SEVERAL VIEWS OF THE DRAWINGS

Technical solutions and features of the present invention are hereunder illustrated with preferred embodiments in conjunction with the accompanying drawings, in which:

FIG. 1 is a perspective view of a pump dispenser bottle hanger according to a first preferred embodiment of the present invention, illustrating that a pump dispenser bottle is disposed at the pump dispenser bottle hanger;

FIG. 2 is a lateral view of the pump dispense bottle hanger according to the first preferred embodiment of the present invention;

FIG. 3 is a top view of the pump dispenser bottle hanger according to the first preferred embodiment of the present invention, illustrating that a pump dispenser bottle with a plurality of neck dimensions is disposed at the pump dispenser bottle hanger;

FIG. 4 is atop view of the pump dispenser bottle hanger according to a second preferred embodiment of the present invention;

FIG. 5 and FIG. 6 are perspective views of the pump dispenser bottle hanger according to a third preferred embodiment of the present invention;

FIG. 7 is a partial lateral view of the pump dispenser bottle hanger according to the third preferred embodiment of the present invention; and

FIG. 8 is partial lateral view of the pump dispenser bottle hanger according to a fourth preferred embodiment of the present invention.

### DETAILED DESCRIPTION OF THE EMBODIMENTS OF THE INVENTION

Referring to FIG. 1 and FIG. 2, in a first preferred embodiment of the present invention, a pump dispenser bottle hanger 10 essentially comprises a hanging board 20 and a fixing board 30 which are connected to each other. A pump dispenser bottle 40 can be disposed fixedly on the hanging board 20. The pump dispenser bottle hanger 10 is fixed to a wall surface by means of the fixing board 30, such that the pump dispenser bottle 40 is hung on the wall surface.

In this embodiment, the pump dispenser bottle hanger 10 is formed integrally as a unitary structure by an aluminum extrusion process and then undergoes fine-feature processing; however, the method of manufacturing the pump dispenser bottle hanger 10 is not limited thereto. Fine features and advantages of the hanging board 20 and the fixing board 30 of the pump dispenser bottle hanger 10 are described in detail below.

The hanging board 20 is defined with a top surface 21, a bottom surface 22, a front end 23, a rear end 24, and two lateral sides 25. The hanging board 20 has a clamping slot 26 that opens into the hanging board 20 from the front end 23 toward the rear end 24 and penetrates the top surface 21 and the bottom surface 22. Referring to FIG. 3, the clamping slot 26 has a front segment 262, a middle segment 264, and a rear segment 266 which are arranged in sequence in the direction from the front end 23 to the rear end 24. The rear segment 266 has a curved stop edge 266a. The middle segment 264 has two opposing oblique edges 264a connected to the stop edge 266a. The two oblique edges 264a each extend from the junction of the oblique edge 264a and the stop edge 266a and in the direction of the front segment 262.

Referring to FIG. 1 and FIG. 2, due to its features, the hanging board 20 clamps a neck 422 of a bottle body 42 of the pump dispenser bottle 40 by means of the clamping slot 26. A cap 46 with a press head 44 can be screwed tightly to the neck 422 of the bottle body 42, such that the hanging board 20 is clamped and fixed in place between the cap 46 and a body cylinder 424 of the pump dispenser bottle 40. Referring to FIG. 3, the clamping slot 26 of the hanging board 20 clamps a pump dispenser bottle 40A with a neck diameter substantially equal to the longest distance between the two oblique edges 264a. Alternatively, the clamping slot 26 of the hanging board 20 clamps a pump dispenser bottle 40B with a neck diameter substantially equal to the shortest distance between the two oblique edges 264a. Alternatively, the clamping slot 26 of the hanging board 20 clamps a pump dispenser bottle 40C with a neck diameter shorter than that of the pump dispenser bottle 40A but longer than that of the pump dispenser bottle 40B. FIG. 3 shows the shape of the necks of the pump dispenser battles 40A, 40B, 40C. Hence, the pump dispenser bottle hanger 10 is applicable to pump dispenser bottles with a plurality of neck dimensions.

Referring to FIG. 3, in this embodiment, the front segment 262 of the clamping slot 26 of the hanging board 20 has two parallel opposing inner edges 262a. Furthermore, the hanging board 20 has two inner chamfers 27 and two outer chamfers 28. The inner chamfer 27 is connected between the inner edge 262a and the front end 23. The outer chamfer 28 is connected between the lateral side 25 and the front end 23. The radius of curvature of the outer chamfers 28 is less than the radius of curvature of the inner chamfers 27. Hence, the inner and outer chamfers 27, 28 are round enough to ensure user safety. The relatively small radius of curvature of the outer chamfers 28 precludes overly reduction in the mechanical strength of the hanging board 20. The relatively large radius of curvature of the inner chamfers 27 is required for the ease of entry of the neck of the pump dispenser bottle 40A into the clamping slot 26. The inner edges 262a are parallel instead of oblique, such that the neck of the pump dispenser bottle 40A is slightly stopped by the middle segment 264 of the clamping slot 26 while passing the middle segment 264 of the clamping slot 26, but the neck of the pump dispenser bottle 40A manages to pass the middle segment 264 of the clamping slot 26 eventually.

The fixing board 30 extends downward from the hanging board 20, is substantially perpendicular to the hanging board 20, and has a hanging hole 32 formed to penetrate the fixing board 30. Hence, with the hanging hole 32, the fixing board 30 is hung on a nail fixed to the wall surface or hung on a hook fixed to the wall surface. Alternatively, the fixing board 30 is adhered to the wall surface, and thus the fixing board 30 can be dispensed with the hanging hole 32.

Referring to FIG. 1 and FIG. 2, the pump dispenser bottle hanger 10 further comprises a reinforcing rib 50. The reinforcing rib 50 is connected between the fixing board 30 and the bottom surface 22 of the hanging board 20 and adapted to reinforce the pump dispenser bottle hanger 10. The junction of the reinforcing rib 50 and the bottom surface 22 is spaced apart from the clamping slot 26 by a distance to prevent the contact between the body cylinder 424 and the reinforcing rib 50 which might otherwise preclude the pump dispenser bottle 40 from being carried by the pump dispenser bottle hanger 10.

In this embodiment, the fixing board 30 and the rear end 24 of the hanging board 20 are connected together to form a unitary structure; however, the portion of the hanging board 20, to which the fixing board 30 is connected, is not limited thereto. Furthermore, this embodiment is not restrictive of the shape of the hanging board 20 and the fixing board 30. The objective of the pump dispenser bottle hanger of the present invention and other objectives can be achieved, provided that the fixing board 30 extends downward from the hanging board 20 and is fixed to the wall surface. With the fixing board 30 extending downward from the hanging board 20, the pump dispenser bottle hanger 10 not only manifests high structural strength and thus is unlikely to deform or sever, but a user can also exert a force downward and easily to thereby press the press head 44.

The purpose of the rear segment 266 of the clamping slot 26 of the hanging board 20 is to create a space for receiving the neck 422 of the pump dispenser bottle 40 and allow the neck 422 of the pump dispenser bottle 40 to abut against the stop edge 266a; hence, the stop edge 266a is not necessarily curved. For instance, referring to FIG. 4, in a second preferred embodiment of the present invention, a pump dispenser bottle hanger 60 is characterized by the V-shaped stop edge 266a of the rear segment 266 of the clamping slot 26 of the hanging board 20, thereby achieving the objective of the present invention.

Referring to FIG. 5 through FIG. 7, a pump dispenser bottle hanger 70 provided in a third preferred embodiment of the present invention is different from the pump dispenser bottle hanger 10 in that two anti-skid structures 81, 82, which are convolute, are disposed on the top surface 21 and the bottom surface 22 of the hanging board 20 of the pump dispenser bottle hanger 70, respectively. The two anti-skid structures 81 on the top surface 21 are positioned outside the two oblique edges 264a, respectively, to allow the cap 46 of the pump dispenser bottle 40 to be firmly coupled to the hanging board 20 and thus unlikely to slide. The two anti-skid structures 82 on the bottom surface 22 are positioned outside the two oblique edges 264a, respectively, to allow the body cylinder 424 of the pump dispenser bottle 40 to be firmly coupled to the hanging board 20 and thus unlikely to slide. The anti-skid structures 81, 82 are disposed on the top surface 21 of the hanging board 20 and on the bottom surface 22 of the hanging board 20. Alternatively, the anti-skid structures 81 are disposed on the top surface 21 only. Alternatively, the anti-skid structures 82 are disposed on the bottom surface 22 only. Hence, the pump dispenser bottle 40 and the hanging board 20 are coupled together firmly.

In the third preferred embodiment, the anti-skid structures 81, 82 of the hanging board 20 each comprise a plurality of protruding portions 812, 822. The protruding portions 812 of the two anti-skid structures 81 on the top surface 21 extend from the two oblique edges 264a to the two lateral sides 25, respectively. The protruding portions 822 of the two anti-skid structures 82 on the bottom surface 22 extend from the two oblique edges 264a to the two lateral sides 25, respectively. However, forms and configuration of the anti-skid structures 81, 82 are not limited thereto. For instance, referring to FIG. 8, in a fourth preferred embodiment of the present invention, a pump dispenser bottle hanger 90 is characterized in that anti-skid structures 81′, 82′ of the top surface 21 and the bottom surface 22 of the hanging board 20 comprise a plurality of dented portions 812′, 822′ which are arranged in the same way as the protruding portions 812, 822 are, such that the pump dispenser bottle 40 and the hanging board 20 are firmly coupled together.

As regards the pump dispenser bottle hangers 70, 90 in the third and fourth preferred embodiments, the protruding portions 812, 822 of the anti-skid structures 81, 82 and the dented portions 812′, 822′ of the anti-skid structures 81′, 82′ extend horizontally from the oblique edge 264a of the clamping slot 26 to the lateral sides 25 of the hanging board 20, such that the anti-skid structures can be manufactured by an aluminum extrusion process and thus need not undergo a subsequent process.

In conclusion, the present invention provides a pump dispenser bottle hanger that applies to pump dispenser bottles with a plurality of neck dimensions, manifests high structural strength, is unlikely to damage or sever, and allows users to press the pump dispenser bottles easily.

The constituent elements disclosed in the aforesaid embodiments of the present invention are illustrative rather than restrictive of the scope of the present invention, and thus changes or replacements of equivalent elements are covered by the claims of the present invention.

What is claimed is:

1. A pump dispenser bottle hanger, comprising:
a hanging board having two surfaces defined as a top surface and a bottom surface, respectively, and two ends defined as a front end and a rear end, respectively, the hanging board having a clamping slot opening into the hanging board from the front end toward the rear end and penetrating the top surface and the bottom surface, the clamping slot having a front segment, a middle segment, and a rear segment arranged in sequence in a direction from the front end to the rear end, the rear segment having a stop edge, the middle segment having two opposing oblique edges connected to the stop edge, the two oblique edges each extending from a junction of the oblique edge and the stop edge and in a direction of the front segment; and
a fixing board extending downward from the hanging board.

2. The pump dispenser bottle hanger of claim 1, wherein two anti-skid structures are disposed on the top surface of the hanging board or on the bottom surface of the hanging board and are outside the two oblique edges, respectively.

3. The pump dispenser bottle hanger of claim 2, wherein the anti-skid structures each comprise a plurality of protruding portions extending from the two oblique edges to two lateral sides of the hanging board, respectively.

4. The pump dispenser bottle hanger of claim 2, wherein the anti-skid structures each comprise a plurality of dented portions extending from the two oblique edges to two lateral sides of the hanging board, respectively.

5. The pump dispenser bottle hanger of claim 1, wherein two anti-skid structures are disposed on the top surface of the hanging board and on the bottom surface of the hanging board, wherein the two anti-skid structures on the top surface are outside the two oblique edges, respectively, wherein the two anti-skid structures on the bottom surface are outside the two oblique edges, respectively.

6. The pump dispenser bottle hanger of claim 1, wherein the front segment of the clamping slot of the hanging board has two parallel opposing inner edges.

7. The pump dispenser bottle hanger of claim 6, wherein the hanging board has two inner chamfers each connected between a corresponding one of the inner edges and a corresponding one of the front ends of the front segment of the clamping slot.

8. The pump dispenser bottle hanger of claim 7, wherein the hanging board has two lateral sides and two outer chamfers connected between the front end and the two lateral sides, respectively, wherein a radius of curvature of the outer chamfers is less than a radius of curvature of the inner chamfers.

9. The pump dispenser bottle hanger of claim 1, wherein a hanging hole is disposed in the fixing board to penetrate the fixing board.

10. The pump dispenser bottle hanger of claim 1, further comprising a reinforcing rib connected between the fixing hoard and the bottom surface of the hanging board, wherein a junction of the reinforcing rib and the bottom surface is spaced apart from the clamping slot by a distance.
